(19) United States
(12) Patent Application Publication
(10) Pub. No.: US 2012/0330955 A1
(43) Pub. Date: Dec. 27, 2012

(54) DOCUMENT SIMILARITY CALCULATION DEVICE

(75) Inventor: Mitsugu MIURA, Tokyo (JP)

(73) Assignee: NEC Corporation, Tokyo (JP)

(21) Appl. No.: 13/472,414

(22) Filed: May 15, 2012

(30) Foreign Application Priority Data
Jun. 27, 2011 (JP) 2011-141329

(51) Int. Cl. G06F 17/30

(52) U.S. Cl. 707/737; 707/E17.089

(57) ABSTRACT

A document similarity calculation device, configured to calculate a similarity indicating a degree of how much a plurality of documents are similar, includes: an associative word group storage portion for storing an associative word group composed of words associated with one another, a word-in-document frequency matrix generation portion for generating a matrix of word frequency in document which is a matrix each element of which is the frequency of a word present in a document with respect to each combination of the word and the document, a word-in-document frequency matrix transformation portion for transforming the generated matrix of word frequency in document based on the stored associative word group so as to reduce the number of dimensions of the matrix of word frequency in document, and a similarity calculation portion for calculating the similarity based on the transformed matrix of word frequency in document.

### INCORPORATION BY REFERENCE

The present application claims priority from Japanese Patent Application No. 2011-141329, filed on Jun. 27, 2011 in Japan, the disclosure of which is incorporated herein by reference in its entirety.

### TECHNICAL FIELD

The present invention relates to document similarity calculation devices for calculating a similarity indicating a degree of how much a plurality of documents are similar to one another.

### BACKGROUND ART

There are known document similarity calculation devices for calculating a similarity indicating a degree of how much a plurality of documents are similar to one another. As one of such document similarity calculation devices, the document similarity calculation device disclosed in the following Patent Document 1 generates a matrix of word frequency in document. Here, the matrix of word frequency in document is furnished as its elements with the frequency of a word present in a document with respect to each combination of the word and the document.

Next, the document similarity calculation device generates a documentation feature vector denoting the feature of each document by decomposing a singular value of the generated matrix of word frequency in document. Then, the document similarity calculation device calculates the similarity based on the generated documentation feature vector.
[Patent Document 1] JP 2006-139708 A

However, when increasing the number of documents for calculating the similarity, the above-mentioned document similarity calculation device generates the matrix of word frequency in document for every document and, once again, carries out the process of decomposing the singular value of the generated matrix of word frequency in document. Therefore, the above-mentioned document similarity calculation device may assume a risk of bearing an excessive processing load for calculating the similarity.

### SUMMARY

Therefore, an exemplary object of the present invention is to provide a document similarity calculation device capable of solving the above problem of giving rise to “the case of bearing an excessive processing load”.

In order to achieve this exemplary object, an aspect in accordance with the present invention provides a document similarity calculation device for calculating a similarity indicating a degree of how much a plurality of documents are similar to one another.

Further, the document similarity calculation device includes: a unit of storing associative word group for storing an associative word group composed of words associated with one another; a unit of generating matrix of word frequency in document for generating a matrix of word frequency in document which is a matrix each element of which is the frequency of a word present in a document with respect to each combination of the word and the document; a unit of transforming matrix of vvnrd frequency in document for transforming the generated matrix of word frequency in document based on the stored associative word group so as to reduce the number of dimensions of the matrix of word frequency in document; and a unit of calculating similarity for calculating the similarity based on the transformed matrix of word frequency in document.

Further, another aspect in accordance with the present invention provides a document similarity calculation method for calculating a similarity indicating a degree of how much a plurality of documents are similar to one another.

Further, the document similarity calculation method includes: prestoring an associative word group composed of words associated with one another; generating a matrix of word frequency in document which is a matrix each element of which is the frequency of a word present in a document with respect to each combination of the word and the document; transforming the generated matrix of word frequency in document based on the stored associative word group so as to reduce the number of dimensions of the matrix of word frequency in document; and calculating the similarity based on the transformed matrix of word frequency in document.

Further, still another aspect in accordance with the present invention provides a document similarity calculation program for causing an information processing device to carry out a process for calculating a similarity indicating a degree of how much a plurality of documents are similar to one another.

Further, the process includes: prestoring an associative word group composed of words associated with one another; generating a matrix of word frequency in document which is a matrix each element of which is the frequency of a word present in a document with respect to each combination of the word and the document; transforming the generated matrix of word frequency in document based on the stored associative word group so as to reduce the number of dimensions of the matrix of word frequency in document; and calculating the similarity based on the transformed matrix of word frequency in document.

According to the present invention configured in the above manner, it is possible to reduce the processing load.

### BRIEF DESCRIPTION OF DRAWINGS

FIG. 1 is a diagram showing a schematic configuration of a document search system in accordance with a first exemplary embodiment of the present invention;

FIG. 2 is a block diagram showing an outline of the function of a server device in accordance with the first exemplary embodiment of the present invention;

FIG. 3 is a table showing an exemplary matrix of word frequency in document in accordance with the first exemplary embodiment of the present invention;

FIG. 4 is a table showing an example of associative word group stored by the server device in accordance with the first exemplary embodiment of the present invention;

FIG. 5 is a flowchart showing a computer program implemented by the server device in accordance with the first exemplary embodiment of the present invention; and

FIG. 6 is a block diagram showing an outline of the function of a document similarity calculation device in accordance with a second exemplary embodiment of the present invention.

### EXEMPLARY EMBODIMENTS

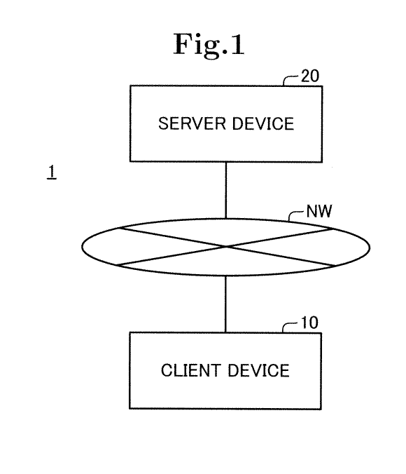

Hereinbelow, referring to FIGS. 1 to 6, explanations will be made with respect to every exemplary embodiment of a document similarity calculation device, a document similarity calculation method, and a document similarity calculation program, in accordance with the present invention.

### A First Exemplary Embodiment

(Configuration)

As shown in FIG. 1, a document search system 1 in accordance with a first exemplary embodiment includes a client device 10, and a server device 20 (a document similarity calculation device). The client device 10 and the server device 20 are connected to be capable of communications with each other via a communication line NW (constituting an IP (Internet Protocol) network in the firs exemplary embodiment).

The client device 10 is an information processing device (a personal computer in the first exemplary embodiment). Further, the client device 10 may as well be a cell-phone terminal, a PHS (Personal Handy-phone System), a PDA (Personal Data Assistance; Personal Digital Assistant), a smartphone, a car navigation terminal, a game machine terminal, or the like.

The client device 10 includes a CPU (Central Processing Unit), a storage device (memory, and HDD: Hard Disk Drive), an input device (a keyboard and a mouse in the first exemplary embodiment), and an output device (a display in the first exemplary embodiment), which are all not shown.

The client device 10 is configured to realize an aftermentioned function by letting the CPU implement a computer program stored in the storage device.

The server device 20 is another information processing device. In common with the client device 10, the server device 20 also includes a CPU and a storage device which are not shown. In analogy with the client device 10, the server device 20 is also configured to realize an aftermentioned function by letting the CPU implement a computer program stored in the storage device.

(Function)

The function of the client device 10 includes accepting the word (character string) as a search word inputted by a user via the input device, and sending the accepted search word to the server device 20.

Further, the function of the client device 10 also includes receiving the search result sent by the server device 20, and outputting the received search result via the output device (showing the same on the display in the first exemplary embodiment). Here, the search result is information showing a list of document identification information for identifying a document (for example, URI (Uniform Resource Identifier), and paths (file paths) and the like in the file system).

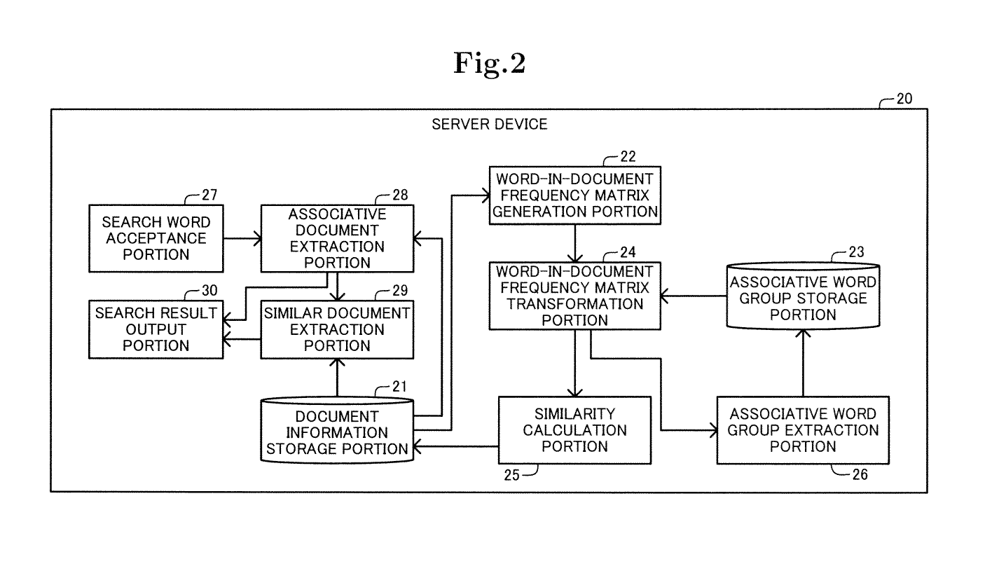

Further, as shown in FIG. 2, the function of the server device 20 includes a document information storage portion 21, a word-in-document frequency matrix generation portion 22 (a unit of generating matrix of word (term) frequency in document), an associative word group storage portion 23 (a unit of storing associative word group), a word-in-document frequency matrix transformation portion 24 (a unit of transforming matrix of word frequency in document), a similarity calculation portion 25 (a unit of calculating similarity), an associative word group extraction portion 26 (a unit of extracting associative word group), a search word acceptance portion 27 (a unit of accepting search word), an associative document extraction portion 28 (a unit of extracting associative document), a similar document extraction portion 29 (a unit of extracting similar document), and a search result output portion 30 (a unit of outputting search result).

The document information storage portion 21 stores a plurality of pieces of document information. In the first exemplary embodiment, the document information includes a document, document distinction information for distinguishing the document, and document identification information for identifying the document (URI, file path and the like in the first exemplary embodiment). The document includes at least one sentence. A sentence is constituted by a character string composed of a plurality of characters.

In the first exemplary embodiment, the server device 20 receives a document from another server device connected via the communication line NW (for example, a document of a web server, a document of a file server, and the like), and then stores the document information with respect to the received document into the document information storage portion 21. Further, the server device 20 may as well be configured to accept the document information inputted by the user, and then store the accepted document information into the document information storage portion 21.

Further, the document information storage portion 21 stores the transposition indexes for all the documents stored by the document information storage portion 21. A transposition index is information associating the document distinction information for distinguishing a document, a word present in the document, and the position of the word present in the document.

In the first exemplary embodiment, the document information storage portion 21 generates the transposition index by carrying out morphological analysis for each of the documents stored by the document information storage portion 21. Further, when storing new document information, the document information storage portion 21 updates the stored transposition indexes.

Further, the document information storage portion 21 stores the similarity calculated by the after mentioned similarity calculation portion 25. The similarity indicates a degree of how much a plurality of documents are similar to one another.

The word-in-document frequency matrix generation portion 22 generates the matrix of word (term) frequency in document based on the transposition index stored in the document information storage portion 21. The matrix of word frequency in document is furnished as its elements with the frequency of a word present in a document with respect to each combination of the word and the document.

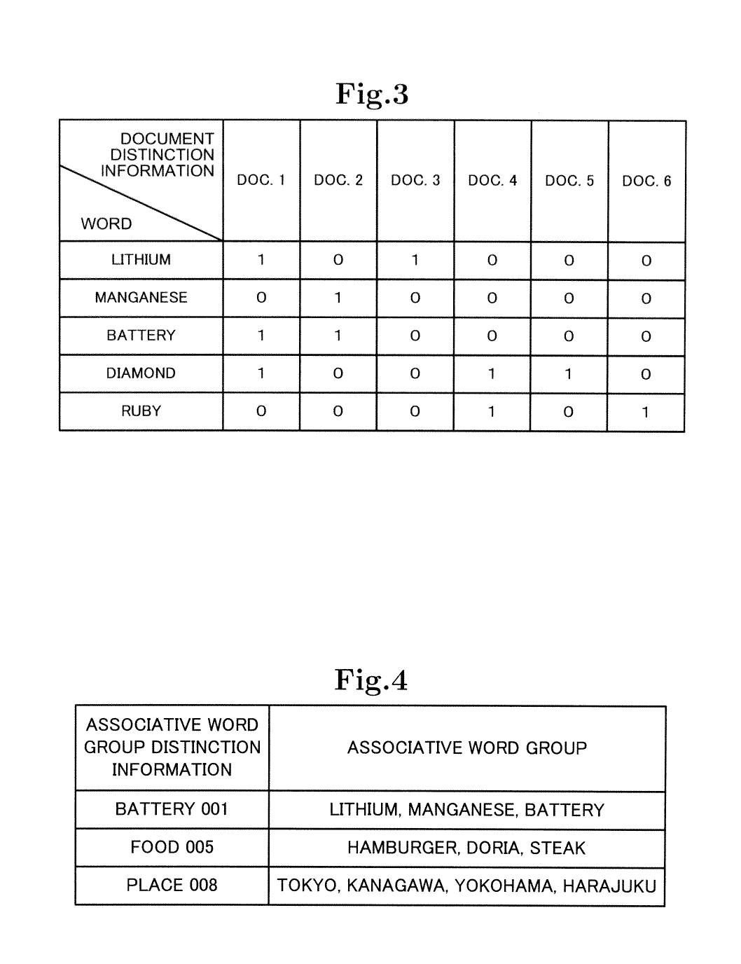

In the first exemplary embodiment, as shown in FIG. 3, the matrix of word frequency in document is such a matrix as sets each of its elements to be the present frequency (number of times) of a word assigned to the row of the element in a document distinguished by the document distinction information assigned to the column of the element in the case of assigning different words to different rows and assigning different document distinction information to different columns.

The associative word group storage portion 23 stores the associative word group extracted by the aftermentioned associative word group extraction portion 26. An associative word group is composed of words associated with one another (for example, synonyms, words with similar meanings, antonyms, compound words, derivative words, idioms, and the like). In the first exemplary embodiment, as shown in FIG. 4, the associative word group storage portion 23 associates an associative word group (a plurality of words) with associative word group distinction information for distinguishing the associative word group, and stores the both.

The word-in-document frequency matrix transformation portion 24 transforms the matrix of word frequency in document based on the associative word groups stored in the associative word group storage portion 23 so as to reduce the number of dimensions of the matrix of word frequency in document generated by the word-in-document frequency matrix generation portion 22.

In particular, the word-in-document frequency matrix transformation portion 24 transforms the matrix of word frequency in document by replacing the row composed of the elements with respect to every word included in the associative word group stored in the associative word group storage portion 23 with a row furnished as its elements with the sum of the elements with respect to every word included in the associative word group respectively.

The similarity calculation portion 25 calculates the similarity between the documents based on the (transformed) matrix of word frequency in document transformed by the word-in-document frequency matrix transformation portion 24.

In the first exemplary embodiment, if the number of documents as the base of generating the matrix of word frequency in document (that is, the number of documents stored in the document information storage portion 21) is smaller than a preset threshold value, then the similarity calculation portion 25 calculates the similarity based on the matrix of word frequency in document generated by the word-in-document frequency matrix generation portion 22. On the other hand, if the number of documents as the base of generating the matrix of word frequency in document is equal to or larger than the above threshold value, then the similarity calculation portion 25 calculates the similarity based on the matrix of word frequency in document transformed by the word-in-document frequency matrix transformation portion 24.

In particular, the similarity calculation portion 25 calculates, as the similarity, the cosine of the angle formed between a first column vector constituting the matrix of word frequency in document and a second column vector constituting the matrix of word frequency in document. This similarity indicates the degree of how much the first document distinguished by the document distinction information assigned to the first column vector is similar to the second document distinguished by the document distinction information assigned to the second column vector.

In the first exemplary embodiment, the similarity calculation portion 25 calculates the similarity for every combination of the documents stored in the document information storage portion 21, respectively.

The associative word group extraction portion 26 extracts the associative word group based on the matrix of word frequency in document transformed by the word-in-document frequency matrix transformation portion 24. In particular, the associative word group extraction portion 26 extracts the associative word group by decomposing the singular value of the transformed matrix of word frequency in document.

In the first exemplary embodiment, the associative word group extraction portion 26 transforms the row vector with respect to each word so as to reduce the number of dimensions by decomposing the singular value of the transformed matrix of word frequency in document, and calculates the degree of association between the words based on the transformed row vector. Here, the degree of association indicates a degree of how much a plurality of words are associated with one another.

The associative word group extraction portion 26 extracts, as an associative word group, the set of the words with the calculated degree of association being larger than a preset threshold value. Further, the associative word group extraction portion 26 may as well be configured to extract the associative word group through clustering based on the calculated degree of association.

The search word acceptance portion 27 receives (accepts) the search word sent by the client device 10.

The associative document extraction portion 28 extracts the associative document associated with the search word (for example, including the search word) accepted by the search word acceptance portion 27 from the documents stored in the document information storage portion 21 based on the transposition index stored in the document information storage portion 21.

The similar document extraction portion 29 extracts the similar document analogous to the associative document extracted by the associative document extraction portion 28 from the documents stored in the document information storage portion 21 based on the similarity stored in the document information storage portion 21 (i.e. calculated by the similarity calculation portion 25). In the first exemplary embodiment, the similar document extraction portion 29 extracts the document with the similarity to the extracted document being higher than a preset threshold value, as a document analogous to the associative document (a similar document).

The search result output portion 30 outputs the information for identifying the associative document extracted by the associative document extraction portion 28, and the similar document extracted by the similar document extraction portion 29. In the first exemplary embodiment, the search result output portion 30 sends to the client device 10, the search result which is the information showing a list of the document identification information for identifying the extracted associative document, and the document identification information for identifying the extracted similar document.

(Operation)

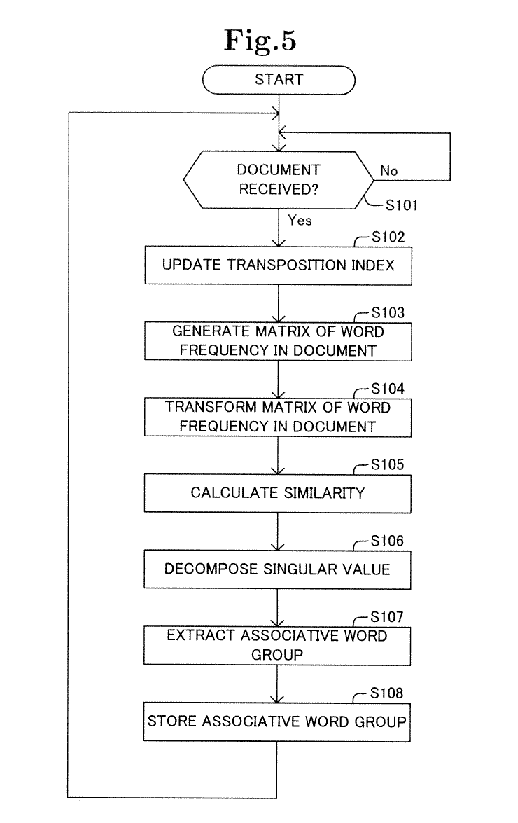

Next, operation of the aforementioned document search system 1 will be explained. The server device 20 is configured to implement the computer program shown by the flowchart in FIG. 5.

To describe it specifically, the server device 20 stands by until receiving a document (the step S101). Then, on receiving a document, the server device 20 determines the present step as “Yes”, and proceeds to the step S102 to store the document information with respect to the received document. Further, the server device 20 updates the stored transposition index by carrying out morphological analysis for the received document.

Next, the server device 20 generates a matrix of word frequency in document based on the stored transposition index (the step S103).

Then, the server device 20 transforms the matrix of word frequency in document based on the stored associative word group so as to reduce the number of dimensions of the generated matrix of word frequency in document (the step S104). In the first exemplary embodiment, the server device 20 transforms the matrix of word frequency in document by replacing the row composed of the elements with respect to every word included in the stored associative word group with a row furnished as its elements with the sum of the elements with respect to every word included in the associative word group respectively.

Next, the server device 20 calculates the similarity between the documents based on the transformed matrix of word frequency in document (the step S105). In the first exemplary embodiment, the server device 20 calculates the similarity for every combination of the stored documents, respectively. Further, the server device 20 stores the calculated similarity.

Next, the server device 20 transforms the row vector with respect to each word so as to reduce the number of dimensions by decomposing the singular value of the transformed matrix of word frequency in document, and calculates the degree of association between the words based on the transformed row vector. Further, the server device 20 extracts, as an associative word group, the set of the words with the calculated degree of association being larger than a preset threshold value (the step S107). Then the server device 20 stores the extracted associative word group (the step S108).

Thereafter, the server device 20 returns to the step S101, and repeats the process from the step S101 to the step S108.

Then, suppose that the user has inputted a search word to the client device 10 via the input device. In this case, the client device 10 accepts the search word inputted by the user. Then, the client device 10 sends the accepted search word to the server device 20.

On the other hand, the server device 20 receives the search word from the client device 10. Subsequently, the server device 20 extracts the associative document associated with the search word from the stored documents based on the stored transposition index.

Then, the server device 20 extracts the similar document analogous to the extracted associative document from the stored documents based on the stored similarity. Thereafter, the server device 20 sends to the client device 10, the search result showing a list of the document identification information for identifying each of the extracted associative document and the extracted similar document.

On the other hand, the client device 10 receives the search result sent by the server device 20, and outputs the received search result via the output device.

As explained hereinabove, the server device 20 in accordance with the first exemplary embodiment of the present invention calculates the similarity based on the matrix of word frequency in document with the reduced number of dimensions (i.e. after the transformation). By virtue of this, it is possible to reduce the processing load for calculating the similarity compared with the case of calculating the similarity based on the generated matrix of word frequency in document (i.e. before the transformation).

Further, the server device 20 reduces the number of dimensions of the matrix of word frequency in document based on the stored associative word group. Thereby, it is possible to avoid an excessive processing load for reducing the number of dimensions of the matrix of word frequency in document.

Further, the server device 20 in accordance with the first exemplary embodiment of the present invention is configured to extract the associative word group based on the transformed matrix of word frequency in document.

According to this configuration, the server device 20 extracts the associative word group based on the matrix of word frequency in document with the reduced number of dimensions. Thereby, it is possible to reduce the processing load for extracting the associative word group compared with the case of extracting the associative word group based on the matrix of word frequency in document with the unreduced number of dimensions.

In addition, the server device 20 in accordance with the first exemplary embodiment of the present invention is configured to calculate the similarity based on the generated matrix of word frequency in document if the number of documents as the base of generating the matrix of word frequency in document is smaller than a preset threshold value.

However, in the case of a comparatively small number of documents as the base of generating the matrix of word frequency in document, the processing load for calculating the similarity is unlikely to be so great. On the other hand, in this case, if the number of dimensions of the matrix of word frequency in document were reduced, there would be a risk of decreasing the accuracy of the similarity. Therefore, according to the server device 20, it is possible to calculate the similarity with a high degree of accuracy while avoiding an excessive processing load for calculating the similarity.

### A Second Exemplary Embodiment

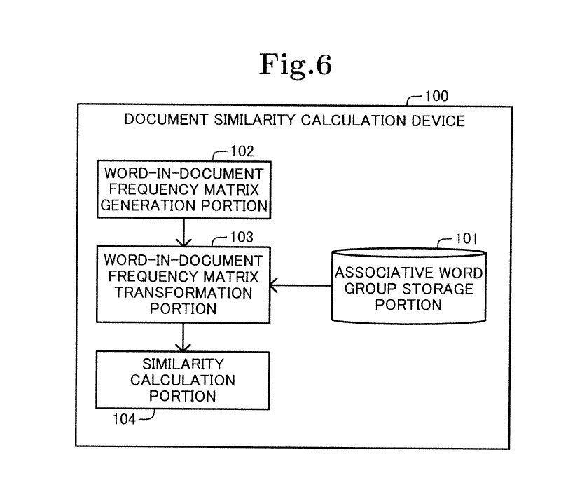

Next, referring to FIG. 6, explanations will be made with respect to a document similarity calculation device in accordance with a second exemplary embodiment of the present invention. The document similarity calculation device 100 in accordance with the second exemplary embodiment is configured to calculate a similarity indicating a degree of how much a plurality of documents are similar to one another.

Further, the document similarity calculation device 100 includes: an associative word group storage portion 101 (a unit of storing associative word group) for storing an associative word group composed of words associated with one another; a word-in-document frequency matrix generation portion 102 (a unit of generating matrix of word frequency in document) for generating a matrix of word frequency in document which is a matrix furnished as its elements with the frequency of a word present in a document with respect to each combination of the word and the document; a word-in-document frequency matrix transformation portion 103 (a unit of transforming matrix of word frequency in document) for transforming the generated matrix of word frequency in document based on the stored associative word group so as to reduce the number of dimensions of the matrix of word frequency in document; and a similarity calculation portion 104 (a unit of calculating similarity) for calculating the similarity based on the transformed matrix of word frequency in document.

According to the above configuration, the document similarity calculation device 100 calculates the similarity based on the matrix of word frequency in document with the reduced number of dimensions. By virtue of this, it is possible to reduce the processing load for calculating the similarity compared with the case of calculating the similarity based on the generated matrix of word frequency in document. Further, the document similarity calculation device 100 reduces the number of dimensions of the matrix of word frequency in document based on the stored associative word group. Thereby, it is possible to avoid an excessive processing load for reducing the number of dimensions of the matrix of word frequency in document.

While the present invention has been particularly shown and described with reference to each of the above-mentioned exemplary embodiments, the present invention is not limited to these embodiments. It will be understood by those of ordinary skill in the art that various changes in form and details may be made therein without departing from the spirit and scope of the present invention as defined by the claims.

For example, although the server device 20 is constituted by one information processing device, it may as well be constituted by a plurality of information processing devices connected to be capable of communications with one another.

Further, although each function of the document similarity calculation device is realized by the CPU implementing a computer program (software) in each of the above exemplary embodiments, it may as well be realized by hardware such as electric circuits and the like.

Further, although the computer program is stored in a storage device in each of the above exemplary embodiments, it may as well be stored in a computer-readable storage medium. For example, the storage medium may be a portable medium such as flexible disks, optical disks, magnet-optical disks, semiconductor memories, and the like.

Further, any combinations of the above exemplary embodiments and some modifications may be adopted as other modifications of the exemplary embodiments.

<Supplementary Notes>

The whole or part of the exemplary embodiment disclosed above can be described as, but not limited to, the following supplementary notes.

(Supplementary Note 1)

A document similarity calculation device for calculating a similarity indicating a degree of how much a plurality of documents are similar to one another, the document similarity calculation device comprising:

a unit of storing associative word group for storing an associative word group composed of words associated with one another;

a unit of generating matrix of word frequency in document for generating a matrix of word frequency in document which is a matrix each element of which is the frequency of a word present in a document with respect to each combination of the word and the document;

a unit of transforming matrix of word frequency in document for transforming the generated matrix of word frequency in document based on the stored associative word group so as to reduce the number of dimensions of the matrix of word frequency in document; and

a unit of calculating similarity for calculating the similarity based on the transformed matrix of word frequency in document.

According to the above configuration, the document similarity calculation device calculates the similarity based on the matrix of word frequency in document with the reduced number of dimensions. By virtue of this, it is possible to reduce the processing load for calculating the similarity compared with the case of calculating the similarity based on the generated matrix of word frequency in document. Further, the document similarity calculation device reduces the number of dimensions of the matrix of word frequency in document based on the stored associative word group. Thereby, it is possible to avoid an excessive processing load for reducing the number of dimensions of the matrix of word frequency in document.

(Supplementary Note 2)

The document similarity calculation device according to Supplementary Note 1, wherein the unit of transforming matrix of word frequency in document is configured to transform the matrix of word frequency in document by replacing the row composed of the elements with respect to every word included in the stored associative word group with a row each element of which is the sum of the elements with respect to every word included in the associative word group respectively.

(Supplementary Note 3)

The document similarity calculation device according to Supplementary Note 1 or 2 further comprising a unit of extracting associative word group for extracting an associative word group based on the transformed matrix of word frequency in document, wherein the unit of storing associative word group is configured to store the extracted associative word group.

According to this configuration, the document similarity calculation device extracts the associative word group based on the matrix of word frequency in document with the reduced number of dimensions. Thereby, it is possible to reduce the processing load for extracting the associative word group compared with the case of extracting the associative word group based on the matrix of word frequency in document with the unreduced number of dimensions.

(Supplementary Note 4)

The document similarity calculation device according to Supplementary Note 3, wherein the unit of extracting associative word group is configured to extract the associative word group by decomposing a singular value of the transformed matrix of word frequency in document.

(Supplementary Note 5)

The document similarity calculation device according to any of Supplementary Notes 1 to 4, wherein the unit of calculating similarity is configured to calculate the similarity based on the generated matrix of word frequency in document if the number of documents as the base of generating the matrix of word frequency in document is smaller than a preset threshold value.

However, in the case of a comparatively small number of documents as the base of generating the matrix of word frequency in document, the processing load for calculating the similarity is unlikely to be so great. On the other hand, in this case, if the number of dimensions of the matrix of word frequency in document were reduced, there would be a risk of decreasing the accuracy of the similarity. Therefore, by configuring the document similarity calculation device in the above manner, it is possible to calculate the similarity with a high degree of accuracy while avoiding an excessive processing load for calculating the similarity.

(Supplementary Note 6)

The document similarity calculation device according to any of Supplementary Notes 1 to 5 further comprising:

a unit of accepting search word for accepting a search word inputted by a user;

a unit of extracting associative document for extracting an associative document associated with the accepted search word;

a unit of extracting similar document for extracting a similar document analogous to the extracted associative document based on the calculated similarity; and

a unit of outputting search result for outputting information for identifying the extracted associative document and the extracted similar document.

(Supplementary Note 7)

A document similarity calculation method for calculating a similarity indicating a degree of how much a plurality of documents are similar to one another, the document similarity calculation method comprising:

prestoring an associative word group composed of words associated with one another;

generating a matrix of word frequency in document which is a matrix each element of which is the frequency of a word present in a document with respect to each combination of the word and the document;

transforming the generated matrix of word frequency in document based on the stored associative word group so as to reduce the number of dimensions of the matrix of word frequency in document; and

calculating the similarity based on the transformed matrix of word frequency in document.

(Supplementary Note 8)

The document similarity calculation method according to Supplementary Note 7, the method comprising: transforming the matrix of word frequency in document by replacing the row composed of the elements with respect to every word included in the stored associative word group with a row each element of which is the sum of the elements with respect to every word included in the associative word group respectively.

(Supplementary Note 9)

A document similarity calculation program comprising instructions for causing an information processing device to carry out a process for calculating a similarity indicating a degree of how much a plurality of documents are similar to one another, the process comprising:

prestoring an associative word group composed of words associated with one another;

generating a matrix of word frequency in document which is a matrix each element of which is the frequency of a word present in a document with respect to each combination of the word and the document;

transforming the generated matrix of word frequency in document based on the stored associative word group so as to reduce the number of dimensions of the matrix of word frequency in document; and

calculating the similarity based on the transformed matrix of word frequency in document.

(Supplementary Note 10)

The document similarity calculation program according to Supplementary Note 9, wherein the process is configured to transform the matrix of word frequency in document by replacing the row composed of the elements with respect to every word included in the stored associative word group with a row each element of which is the sum of the elements with respect to every word included in the associative word group respectively.

The present invention is applicable to document similarity calculation devices and the like for calculating a similarity indicating a degree of how much a plurality of documents are similar to one another.

1. A document similarity calculation device for calculating a similarity indicating a degree of how much a plurality of documents are similar to one another, the document similarity calculation device comprising:
a unit of storing associative word group for storing an associative word group composed of words associated with one another;
a unit of generating matrix of word frequency in document for generating a matrix of word frequency in document which is a matrix each element of which is the frequency of a word present in a document with respect to each combination of the word and the document;
a unit of transforming matrix of word frequency in document for transforming the generated matrix of word frequency in document based on the stored associative word group so as to reduce the number of dimensions of the matrix of word frequency in document; and
a unit of calculating similarity for calculating the similarity based on the transformed matrix of word frequency in document.

2. The document similarity calculation device according to Claim 1, wherein the unit of transforming matrix of word frequency in document is configured to transform the matrix of word frequency in document by replacing the row composed of the elements with respect to every word included in the stored associative word group with a row each element of which is the sum of the elements with respect to every word included in the associative word group respectively.

3. The document similarity calculation device according to Claim 1 further comprising a unit of extracting associative word group for extracting an associative word group based on the transformed matrix of word frequency in document, wherein the unit of storing associative word group is configured to store the extracted associative word group.

4. The document similarity calculation device according to Claim 3, wherein the unit of extracting associative word group is configured to extract the associative word group by decomposing a singular value of the transformed matrix of word frequency in document.

5. The document similarity calculation device according to Claim 1, wherein the unit of calculating similarity is configured to calculate the similarity based on the generated matrix of word frequency in document if the number of documents as the base of generating the matrix of word frequency in document is smaller than a preset threshold value.

6. The document similarity calculation device according to Claim 1 further comprising:
a unit of accepting search word for accepting a search word inputted by a user;
a unit of extracting associative document for extracting an associative document associated with the accepted search word;
a unit of extracting similar document for extracting a similar document analogous to the extracted associative document based on the calculated similarity; and
a unit of outputting search result for outputting information for identifying the extracted associative document and the extracted similar document.

7. A document similarity calculation method for calculating a similarity indicating a degree of how much a plurality of documents are similar to one another, the document similarity calculation method comprising:
prestoring an associative word group composed of words associated with one another;
generating a matrix of word frequency in document which is a matrix each element of which is the frequency of a word present in a document with respect to each combination of the word and the document;
transforming the generated matrix of word frequency in document based on the stored associative word group so as to reduce the number of dimensions of the matrix of word frequency in document; and
calculating the similarity based on the transformed matrix of word frequency in document.

8. The document similarity calculation method according to Claim 7, the method comprising: transforming the matrix of word frequency in document by replacing the row composed of the elements with respect to every word included in the stored associative word group with a row each element of which is the sum of the elements with respect to every word included in the associative word group respectively.

9. A medium being readable by an information processing device and storing a document similarity calculation program comprising instructions for causing the information processing device to carry out a process for calculating a similarity indicating a degree of how much a plurality of documents are similar to one another, the process comprising:
prestoring an associative word group composed of words associated with one another;
generating a matrix of word frequency in document which is a matrix each element of which is the frequency of a word present in a document with respect to each combination of the word and the document;
transforming the generated matrix of word frequency in document based on the stored associative word group so as to reduce the number of dimensions of the matrix of word frequency in document; and
calculating the similarity based on the transformed matrix of word frequency in document.

10. The medium according to Claim 9, wherein the process is configured to transform the matrix of word frequency in document by replacing the row composed of the elements with respect to every word included in the stored associative word group with a row each element of which is the sum of the elements with respect to every word included in the associative word group respectively.
